(19) United States
(12) Patent Application Publication
(10) Pub. No.: US 2003/0211316 A1
(43) Pub. Date: Nov. 13, 2003

(54) Producing of a roll of a flat web material

(75) Inventors: Christoph Nagel, Hamburg (DE); Thomas Gassner, Heidgraben (DE); Bernhard Gebbeken, Hamburg (DE)

Correspondence Address: Norris, McLaughlin & Marcus P.A., 30th Floor, 220 East 42nd Street, New York, NY, 10017, US

(73) Assignee: TESA AG, Hamburg (DE)

(21) Appl. No.: 10/373,560

(22) Filed: Feb. 25, 2003

(30) Foreign Application Priority Data
Feb. 25, 2002 (DE) 102 07 792.4

(51) Int. Cl. B32B 15/04; B32B 9/00; B32B 33/00; B31C 1/00; B65H 81/00; B32B 7/12

(52) U.S. Cl. 428/343; 156/184; 428/40.1

(57) ABSTRACT

A process for producing a roll of a flat web material, in which first of all a flat web is produced by a conventional method and is wound up to form a roll, and in which the end region of the flat web is bonded to the roll with a spliceable adhesive tape, without the end region of the flat web having been bonded to the roll.

The invention relates to a process for producing a roll of a flat web material, a flat web first of all being produced by a conventional method and wound up to form a roll. In the papermaking and paper processing industries, roll-end bonding is carried out using single of double-sided adhesive tapes. Neither method offers any possibility of using this bonding for the actual flying splice.

Where securement labels are employed in combination with double-sided adhesive tapes the risk exists of these labels tearing as a result of the stresses which can arise in the paper roll during storage.

In the case of singe-sided adhesive tapes, the adhesive tape is bonded parallel to the winding direction of the roll. Thus there is no longer any free bonding area available for actual splicing. One particular form of an adhesive tape for roll-end bonding is described in CA U.S. Pat. No. 2,113,932. There, the carrier splits to release the new paper web without leaving sticky residues. The adhesive tapes used generally feature water-soluble adhesives of particularly high shear strength, which on the one hand remove the risk of failure of the roll-end bond under the high tensile stresses which exist within a paper roll but on the other hand, owing to their water-soluble self-adhesive compositions and paper carrier, so not interfere with re-use of paper wastes in the paper machines.

In the course of further processing, such paper rolls often pass through a splicing operation, in which the topmost web of the new roll is bonded to the end of the outgoing, almost used-up roll, in order to produce a web of paper traveling continuously in the paper process operation. Before the splicing operation, therefore, the adhesive tapes for roll-end bonding must be replaced by an adhesive tape which is able to mediate their bonding to the outgoing web.

In the paper processing industry, roll-end bonding takes place a number of times: for example, on the paper machine after papermaking; upstream of the coating machine after roll transfer; on the coating machine after coating; after calendaring; after roll slitting; and before dispatch. Each time before further processing of the paper rolls, the roll-end bond must be removed and a serviceable adhesive splicing tape attached. Where the rolls are sent to the customer, and where that customer also has to carry out splicing, the customer as well has to remove the roll-end bond and again attach an adhesive splicing tape. This operation requires trained personnel, since the requirements imposed on a precise bond are very exacting. Depending ton the further processing operation, this adhesive tape must possess either high tack or high shear strength.

It is an object of the invention to simplify preparation for the operation of flying splice and at the same time to enhance the reliability of the operation.

This goal of the invention to simplify preparation for the operation of flying splice and at the same time to enhance the reliability of the operation.

This object is achieved by a process as set out ion claim 1. The dependent claims relate to advantageous embodiments of this process.

Claim 1 accordingly provides a process for producing a roll of a flat web material, in which first of all a flat web is produced by a conventional method and is wound up to form a roll, and in which, furthermore, the end region of the flat web is bonded to the roll with a spliceable adhesive tape, without the end region of the flat web having been bonded to the roll.

The flat web material is preferably paper, and so the flat webs are preferably paper webs. Very advantageously, this first bonding step takes place directly at the premises of the papermaker. Also very advantageously, the adhesive tape used is a self-adhesive tape.

In the case of the inventive process, the preparation of new flat web rolls for a subsequent use for flying splice takes place at a very early point in time, very advantageously while still in the paper mill. Here, the new paper roll is provided, for the purpose of roll-end bonding, with the same adhesive tape which is utilized as adhesive splicing tape (spliceable adhesive tape) in the operation of flying splice. This approach offers the following advantages:

1. Saving of worksteps; in accordance with the prior art, the rolls are end-bonded in a first step with conventional adhesive tape, and

2. not until immediately before flying splice are they prepared, in a further step, with the adhesive tape utilized for the splicing operation.

In the invention process, the preparation of the new roll takes place only once. Connected with this is an assurance of quality, since the roll as supplied is already equipped—and by specially trained personnel—with the adhesive tape which can be utilized for the splicing operation in the course of flying splice. The customer con therefore be offered—and supplied with—a finished, ready-prepared product, and the product guarantee as well can be taken on by the manufacturer. Preparation by a team specifically trained for this purpose ensures a consistent quality standard, minimizing the failure rate during flying splice.

he end user who carries out the flying splice is saved the step of roll preparation and the skilled personnel required for that purpose and is able to rationalize his or her plant operation accordingly. Depending on the requirements of the application, said customer can order ready-prepared rolls with high-tack or high-shear strength spliceable self-adhesive tapes, without having to have different sliceable self-adhesive tapes in stock at the plant.

The bonding of the end region serves here to fix the end of the paper well (“the pennant”) to the roll. Very advantageously, an adhesive tape is used which, for the purpose of fixing the flat web, is bonded beneath it.

n one advantageous development of the process of the invention an adhesive tape is used which has an at least subregionally splicing carrier.

In a further advantageous development of the process of the invention an adhesive tape is used with a carrier which is composed of at least two layers connected to one another, the connection being dissolved during the splicing operation.

Splicing self-adhesive tapes which have also proven suitable for the process of the invention are described, inter alia, in the following documents. The technical disclosure content of these documents that describes the self-adhesive tapes is explicitly incorporated here by reference. Particularly suitable for the inventive process are the following adhesive tapes, this list being only exemplary:

Adhesive tape for flying splice, the paper carrier being coated on one side with a water-soluble self-adhesive composition while a part of the reverse of the paper carrier is provided with a double-sided adhesive tape which for its part has a splittable paper carrier provided on both sides with water-soluble self-adhesive composition (cf. e.g. DE 196 28 317).

Adhesive tape for flying splice, having a paper carrier and a water-soluble self-adhesive composition, the paper carrier being coated on both sides with a water-soluble self-adhesive composition and being composed of a splittable paper (cf. e.g. DE 196 32 689 A1).

Adhesive tape for flying splice, having a paper carrier and a water-soluble self-adhesive composition, the paper carrier being coated on one side with a water-soluble self-adhesive composition, and a marginal region of the reverse of the paper carrier being provided with a double-sided adhesive tape which in turn comprises a splittable paper carrier which is provided on both sides with water-soluble self-adhesive composition. (cf. e.g. DE 198 30 674 A1).

Adhesive tape with for flying splice, having a paper carrier and a water-soluble self-adhesive composition, the paper carrier being coated on one side with a water-soluble self-adhesive composition, and a marginal region of the reverse of the paper carrier being provided with a double-sided adhesive tape which in turn comprises a splittable paper carrier which is provided on both sides with water-soluble self-adhesive composition. (cf. e.g. DE 198 30 674 A1)

Adhesive tape with adhesive face and non adhesive reverse, with tow longitudinal edges, for flying roll splice, having

a) a paper carrier (P1) coated unilaterally on the face with a self-adhesive composition (N1),

b) part of the non adhesive reverse of the paper carrier (P1) being provided with a double-sided adhesive tape (DO) which in turn comprises a paper carrier (P2) made of splittable paper, which is coated on both sides with self-adhesive composition (N2, N3), wherein

c) the double-sided adhesive tape (DO) is arranged at the distance (V) of 0.5 to 15 mm form one longitudinal edge (LK) of the adhesive tape. (cf. e.g. DE 199 02 179 A1)

Instead of the adhesive tapes with water-soluble self-adhesive composition it is also possible to use adhesive tapes of corresponding construction wherein the adhesive is not water-soluble.

Furthermore, for the inventive process it is also possible, alternatively, to use all prior art sliceable adhesive tapes which can be adhered beneath (adhesive tapes for flying splice).

The adhesive tapes employed may further comprise a layer which is (mechanically) detectable (aluminum, colored or optical markings, transponders, etc.), so that the further processor can detect and/or isolate the adhesive tape contactlessly. This is of advantage when, for example, the rolls are used, for example, in the printing industry and the splicing operation is detected contactlessly by induction or by reflection or contactlessly by another means.

In the inventive process, bonding can place directly beneath the end edge of the paper web, or else at a certain distance from it.

Where fixing takes place directly at the edge, the adhesive tape is bonded beneath the adhesive tape that protrudes below the edge. The part of the adhesive tape that protrudes below the edge is preferable first covered with a release medium or liner medium (release paper, liner paper, liner film or the like).

here bonding does not take place directly at the edge, only part of an above-applied release medium is removed, so that secure roll-end bonding is ensured. In order to prepare for the splicing operation, the pennant is then cut off or torn off in such a way that the part of the adhesive tape still provided with the release medium is now exposed. When that part has been removed, the roll is ready for flying splice.

For both procedures, the release medium is advantageously provided with a perforation or a slit in the longitudinal direction.

The bonding of the end region of the flat web takes place preferably such that the adhesive tape runs perpendicularly with respect to the longitudinal direction of the flat web, although bonding at an inclined angle may also take place. In this case it is possible to choose, for example, an acute angle of up to 25°, in particular of up to 15°.

In the context of the inventive process, a particularly advantageous procedure is as follows: The flat web material is wound to form a roll and for roll-end bonding an adhesive tape is bonded to the roll beneath the running web so that the splitting system adheres to the roll. In this case only part of the above-applies release medium is removed, so that secure roll-end bonding is ensured. This roll-end bond is highly resistant to stresses in the paper roll, since the splitting system is bonded to the paper roll over the full width and, consequently, withstands high stresses. Subsequently, the flat web material can be rolled up be a few further turns, so that the bond site is protected by the wound-up paper. For final transit, this roll can then be packaged with side plates and a surrounding packaging. The user of the finished rolls is then able to employ them as and when required, as follows.

For the splicing operation, the side plates are first of all removed and then the surrounding packaging. In a variant of the adhesive tape used in accordance with the invention that is particularly worthy of recommendation, a tearing strip is integrated into the remaining release medium, or the remaining release medium itself constitutes the tearing strip. Using this strip, the additionally wound-on paper plies can then be torn open in a targeted manner and hence removed (removal of the pennant).

The inventive process allows the entire transit process within the processing industry to be automated. The adhesive tape used in accordance with the invention unifies the function of the adhesive tape for roll-end bonding and that of the adhesive splicing tape. It can be applied by one person even across large web widths (of more than 5 m, for example); complicated auxiliary means are mechanisms can be omitted.

The invention additionally provided a roll of a flat web material in which the end region of the flat web is bonded for the first time using a spliceable adhesive tape to the roll, in particular a roll of a flat web material, in which an adhesive tape for flying splice is used for bonding, having a paper carrier and a water-soluble self-adhesive composition, and a marginal area of the reverse of the paper carrier is provided with a double-sided adhesive tape which in turn comprises a spliceable paper carrier provided on both sides with water-soluble self-adhesive composition.

What is claimed is:

1. A process for producing a roll of a flat web material, in which first of all a flat web is produced by a conventional method and is wound up to form a roll, and in which the end region of the flat web is bonded to the roll with a spliceable adhesive tape, without the end region of the flat web having been bonded to the roll.

2. The process as claimed in claim 1, wherein the adhesive tape used comprises an at least subregionally splicing carrier.

3. The process as claimed in claim 1, wherein the adhesive tape used comprises a carrier which is composed of at least two layers connected to one another, the connection being dissolved during a splicing operation.

4. The process as claimed in at least one of the preceding claims, wherein an adhesive tape is used for flying splice, comprising a paper carrier and a self-adhesive composition, the paper carrier being coated on one side with a self-adhesive composition, and a marginal region of the reverse of the paper carrier being provided with a double-sided adhesive tape which in turn comprises a spliceable paper carrier which is provided on both sides with self-adhesive composition.

5. A roll of a flat web material, in which the end region of the flat web is bonded to the roll for the first time using a spliceable adhesive tape.

6. A roll of a flat web material in which the end region of the flat web is bonded for the first time using a spliceable adhesive tape to the roll, in which an adhesive tape for flying splice is used for bonding, having a paper carrier and a self-adhesive composition, the paper carrier being coated on one side with the self-adhesive composition, and a marginal area of the reverse of the paper carrier is provided with a double-sided adhesive tape which in turn comprises a spliceable paper carrier provided on both sides with self-adhesive composition.
